(19) United States
(12) Patent Application Publication
(10) Pub. No.: US 2012/0222043 A1
(43) Pub. Date: Aug. 30, 2012

(54) Process Scheduling Using Scheduling Graph to Minimize Managed Elements

(75) Inventors: Alexander G. Gounares, Kirkland, WA (US); Charles D. Garrett, Woodinville, WA (US)

(73) Assignee: CONCURIX CORPORATION, Kirkland, WA (US)

(21) Appl. No.: 13/461,745

(22) Filed: May 1, 2012

(51) Int. Cl. G06F 9/46

(52) U.S. Cl. 718/106

(57) ABSTRACT

A process scheduler may use a scheduling graph to determine which processes, threads, or other execution elements of a program may be scheduled. Those execution elements that have not been invoked or may be waiting for input may not be considered for scheduling. A scheduler may operate by scheduling a current set of execution elements and attempting to schedule a number of generations linked to the currently executing elements. As new elements are added to the scheduled list of execution elements, the list may grow. When the scheduling graph indicates that an execution element will no longer be executed, the execution element may be removed from consideration by a scheduler. In some embodiments, a secondary scan of all available execution elements may be performed on a periodic basis.

### BACKGROUND

Process scheduling is a general term that may refer to how a computer system utilizes its resources. Different levels of process schedulers may manage high level selections such as which applications to execute, while mid-level or low level process schedulers may determine which sections of each application may be executed. A low level process scheduler may perform functions such as time slicing or time division multiplexing that may allocate processors or other resources to multiple jobs.

### SUMMARY

A process scheduler may use a scheduling graph to determine which processes, threads, or other execution elements of a program may be scheduled. Those execution elements that have not been invoked or may be waiting for input may not be considered for scheduling. A scheduler may operate by scheduling a current set of execution elements and attempting to schedule a number of generations linked to the currently executing elements. As new elements are added to the scheduled list of execution elements, the list may grow. When the scheduling graph indicates that an execution element will no longer be executed, the execution element may be removed from consideration by a scheduler. In some embodiments, a secondary scan of all available execution elements may be performed on a periodic basis.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an embodiment showing a system with queue management.

FIG. 2 is a diagram illustration of an embodiment showing an example scheduling graph.

FIG. 3 is a diagram illustration of an embodiment showing an example scheduling graph with executing elements.

FIG. 4 is a flowchart illustration of an embodiment showing a method for executing executable elements from a scheduling graph.

### DETAILED DESCRIPTION

A process scheduler may manage executable elements by identifying executable elements that are likely to be executed once dependencies are cleared. The executable elements waiting on dependencies from other executable elements may be identified from a scheduling graph that may include all of the executable elements of an application. The executing elements may be placed in a runnable queue and those elements that are dependent on the executing elements may be placed in an idle queue.

The process scheduler may manage applications that have a high number of executable elements. In one use scenario, some functional languages such as Haskell, Erlang, and F# may produce numbers of executable elements that range in the hundreds of thousands or even millions for certain applications. By managing only those executable elements that are likely to be executed in the near future, a process scheduler may only handle a more reasonable number of executable elements, thus increasing its performance. In another use scenario, an application execution environment may provide a management layer for an executing application of any type, where the management layer may offload a process scheduler, yielding a potentially faster execution by the process scheduler.

A process scheduler may be an operating system function that schedules executable code on a processor. In many computer systems, a process scheduler may create the illusion of executing several processes concurrently by time slicing or allocating a computing resource to different processes at different time intervals.

The process scheduler may have a queue manager that may analyze a scheduling graph to identify functional elements to add to an idle queue, based on the elements executing in a runnable queue. The scheduling graph may contain each executable element and relationships between those executable elements. The queue manager may traverse the graph to find the elements that may be executed in the near future.

The scheduling graph may identify the functional elements of one or many applications, where an application may be a program that operates independently of other programs on a computer system. When a scheduling graph includes multiple applications, the scheduling graph may be considered a graph of graphs, with each application contributing a group of functional elements that may or may not have relationships with other applications within the overall scheduling graph.

In some embodiments, a queue scheduler may be implemented as a runtime environment in which applications are executed. Such an environment may be a virtual machine component that may have just in time compiling, garbage collection, thread management, and other features. In such an embodiment, a queue scheduler may interface with the runnable and idle queues of an operating system. When a queue scheduler is implemented in a runtime environment, one or more applications may have functional elements defined in the scheduling graph.

In other embodiments, the queue scheduler may be implemented as a component of an operating system. As an operating system component, some or all of the functional elements that are executed by a computer system may be identified within a scheduling graph. Such a scheduling graph may include functions relating to multiple applications as well as operating system functions. In such an embodiment, each operation that may be performed by a computer system may be added to the scheduling graph prior to any execution of such operation.

For the purposes of this specification and claims, the term “executable element” may define a set of instructions that may be executed by a processor. In a typical embodiment, an executable element may be machine level commands that may be sent to a processor. A single computer application may be made up of many executable elements. An executable element may also be referred to as a job, application, code chunk, or other term.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

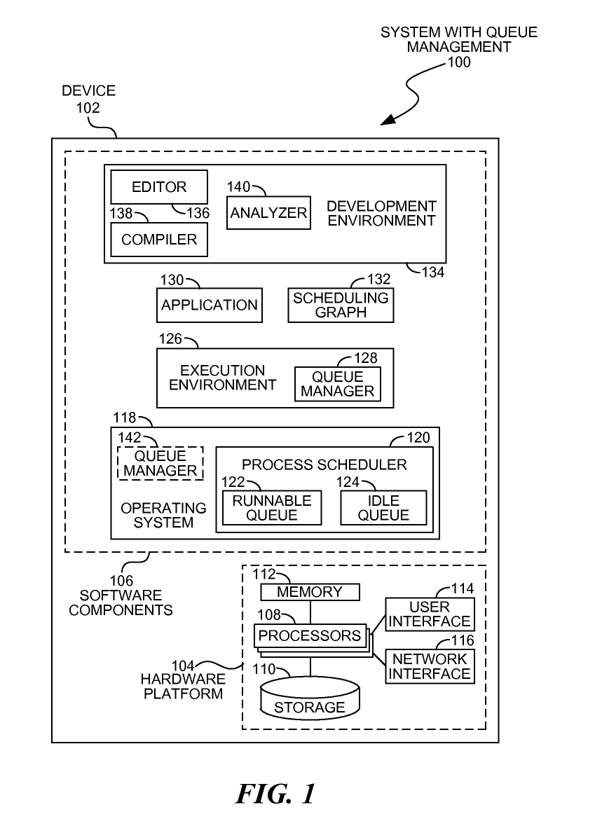

FIG. 1 is a diagram of an embodiment 100 showing a system that may operate a process scheduler based on input from a scheduling graph. Embodiment 100 is a simplified example of the various software and hardware components that may be used an execution environment for applications that may have many executable elements.

The diagram of FIG. 1 illustrates functional components of a system. In some cases, the component may be a hardware component, a software component, or a combination of hardware and software. Some of the components may be application level software, while other components may be operating system level components. In some cases, the connection of one component to another may be a close connection where two or more components are operating on a single hardware platform. In other cases, the connections may be made over network connections spanning long distances. Each embodiment may use different hardware, software, and interconnection architectures to achieve the functions described.

Embodiment 100 illustrates a computer system 102 that may have a process scheduler that may manage executable elements based on knowledge from a scheduling graph. The system may only actively manage those executable elements that have potential to be executed in the near future. Other executable elements that may not be executed soon may be omitted from management by the process scheduler.

A process scheduler may determine which executable elements or portions of a program will be executed by a processor. A process scheduler may allow multiple threads or other executable elements to be executed in parallel by time slicing or time division multiplexing those elements on a processor.

The process scheduler may be known as a CPU scheduler and may determine which of the ready, in-memory processes may be executed following a clock interrupt, I/O interrupt, operating system call, or other form of signal. In some embodiments, the process scheduler may be preemptive, which may allow the process scheduler to forcibly remove executing elements from a processor when the processor may be allocated to another process. In some embodiments, the process scheduler may be non-preemptive, which may be known as voluntary or cooperative process scheduler, where the process scheduler may be unable to force executing elements off of a processor.

In cases where there may be large numbers of executable elements, the process scheduler may limit its analysis to only those executable elements that have a potential to be executed. For some languages, including functional languages, a single application or program may have many thousands, hundreds of thousands, or even millions of executable elements. The sheer number of separate executable elements may cause conventional process schedulers to function slowly and inefficiently.

The executable elements managed by the process scheduler may be significantly reduced by only keeping track of those executable elements that have a potential for being executed in the near future. The set of potential executable elements may be identified by traversing a scheduling graph of an application and including those executable elements that are potentially next in sequence for execution.

The device 102 is illustrated having hardware components 104 and software components 106. The device 102 as illustrated represents a conventional computing device, although other embodiments may have different configurations, architectures, or components.

In many embodiments, the device 102 may be a server computer. In some embodiments, the device 102 may still also be a desktop computer, laptop computer, netbook computer, tablet or slate computer, wireless handset, cellular telephone, game console or any other type of computing device.

The hardware components 104 may include a processor 108, random access memory 110, and nonvolatile storage 112. The hardware components 104 may also include a user interface 114 and network interface 116. The processor 108 may be made up of several processors or processor cores in some embodiments. The random access memory 110 may be memory that may be readily accessible to and addressable by the processor 108. The nonvolatile storage 112 may be storage that persists after the device 102 is shut down. The nonvolatile storage 112 may be any type of storage device, including hard disk, solid state memory devices, magnetic tape, optical storage, or other type of storage. The nonvolatile storage 112 may be read only or read/write capable.

The user interface 114 may be any type of hardware capable of displaying output and receiving input from a user. In many cases, the output display may be a graphical display monitor, although output devices may include lights and other visual output, audio output, kinetic actuator output, as well as other output devices. Conventional input devices may include keyboards and pointing devices such as a mouse, stylus, trackball, or other pointing device. Other input devices may include various sensors, including biometric input devices, audio and video input devices, and other sensors.

The network interface 116 may be any type of connection to another computer. In many embodiments, the network interface 116 may be a wired Ethernet connection. Other embodiments may include wired or wireless connections over various communication protocols.

The software components 106 may include an operating system 118 on which various applications and services may operate. An operating system may provide an abstraction layer between executing routines and the hardware components 104, and may include various routines and functions that communicate directly with various hardware components.

The operating system 118 may include a process scheduler 120 which may have a runnable queue 122 and an idle queue 124. The process scheduler 120 may be a processor-level scheduler which may switch jobs on and off the processors 108 during execution. In some embodiments, a single process scheduler 120 may assign jobs to multiple processors or cores. In other embodiments, each core or processor may have its own process scheduler.

The runnable queue 122 may include all of the executable elements that are ready for execution. In many cases, the runnable executable elements may be held in a queue from which any available processor may pull a job to execute. In an embodiment where each processor may have its own process scheduler, separate runnable queues may be available for each processor.

An idle queue 124 may include executable elements that are blocked and awaiting some input prior to executing. The idle queue 124 may store executable elements that are waiting execution. In many cases, the executable elements in the idle queue 124 may be those executable elements that are waiting for output from items that are being executed. Some embodiments may include items in the idle queue 124 that are waiting for input or other signals from devices, processes, or other hardware or software components within the system.

An execution environment 126 may manage the execution of an application 130. The execution environment 126 may have a queue manager 128 that may manage the executable elements that may be stored in the runnable queue 122 or idle queue 124.

The queue manager 128 may identify individual executable elements from a scheduling graph 132. The scheduling graph 132 may define the relationships between executable elements for a specific application. As one set of executable elements is executing, those executable elements that may receive the output of the executing elements may be added to the idle queue 124.

The scheduling graph 132 may be similar to a control flow graph and may include each block of executable code and the dependencies or other relationships between the blocks. The scheduling graph 132 may be searched and traversed to identify relationships between the executing elements and downstream or dependent elements, and the dependent elements may be added to the idle queue 124.

In some embodiments, dependent executable elements may be prepared for execution as those elements are identified. For example, one such embodiment may retrieve the executable code from disk or other high latency storage area and load the executable code into random access memory, cache, or other lower latency storage area.

The scheduling graph 132 may be created when an application is developed. A development environment 134 may include an editor, 136, compiler 138, and an analyzer 140. A programmer or developer may create a program using the editor 136 and compile the program with the compiler 138. A control flow graph may be created by the compiler 138 or by a secondary analyzer 140 which may be executed after compilation.

From the control flow graph, an analyzer 140 may identify and classify the relationships between executable elements. The relationships may be any type of relationship, including dependencies, parallelism or concurrency identifiers, or other relationships. At compile time, the nature of the relationships may be identified.

The execution environment 126 may be a virtual machine or other mechanism that may manage executing applications. In some cases, the execution environment may provide various management functions, such as just in time compiling, garbage collection, thread management, and other features.

In some embodiments, a queue manager 142 may be part of an operating system 118. In such embodiments, the operating system 118 may operate by receiving a set of functions to perform and a scheduling graph 132. The scheduling graph 132 may include functions that come from many different applications as well as functions that are performed by the operating system itself.

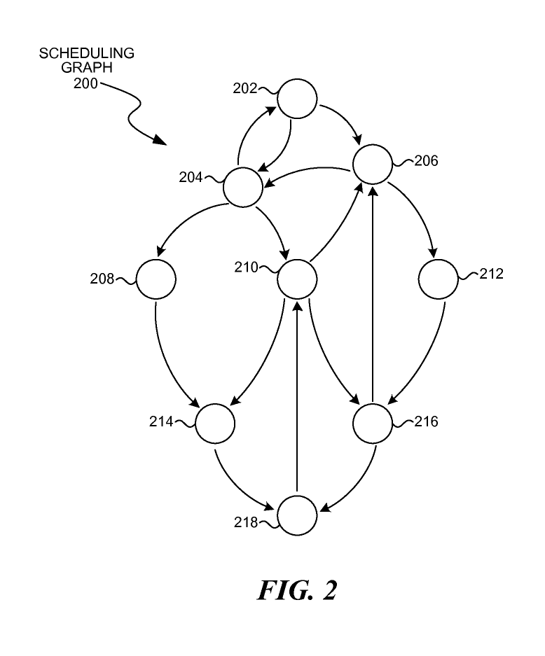

FIG. 2 is a diagram illustration of an embodiment 200 showing an example scheduling graph. Embodiment 200 illustrates several executable elements and the relationships between those elements.

Embodiment 200 illustrates execution elements 202, 204, 206, 208, 210, 212, 214, 216, and 218.

Element 202 is shown having a two-way relationship with element 204, which has a dependent relationship with element 206. Element 206 is illustrated as being dependent on elements 202 or 216.

Element 208 has a dependent relationship with item 204, and element 210 has dependent relationships with elements 204 and 218. Element 212 has a dependent relationship with item 206.

Element 214 has dependent relationships with element 208 and 210. Element 216 has dependent relationships with elements 210 and 212. Lastly, element 218 has dependent relationships with items 214 and 216.

The various elements and relationships in embodiment 200 illustrate different executable elements that may comprise a larger application. As each executable element is completed, control may be passed to another executable element having a relationship with the completed element. In some cases, there may be a branch or other condition that may cause one element to be executed instead of a second. In some cases, two or more elements may be executed simultaneously when a first one completes. Some cases may also have one executing element to spawn dependent elements without stopping the first executing element. Other relationships, situations, and conditions may also be encountered in various embodiments.

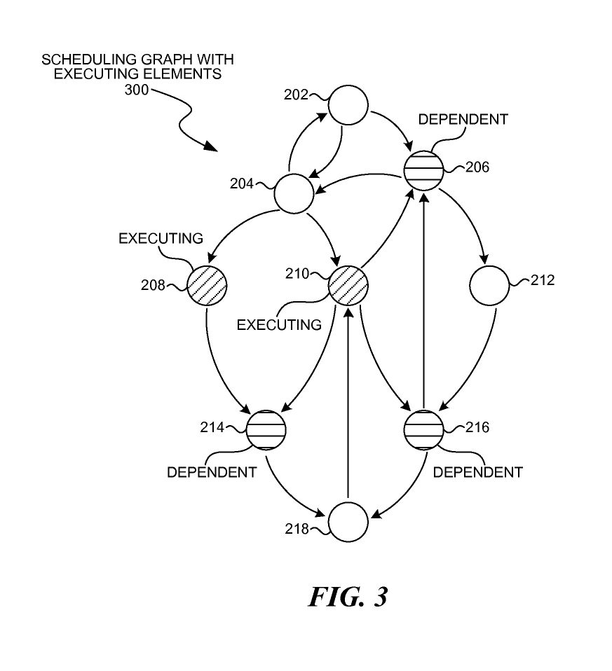

FIG. 3 illustrates an embodiment 300 showing an example condition in which the scheduling graph of embodiment 200 is illustrated.

Embodiment 300 illustrates an example of how dependent executable elements may be identified given a set of executing elements. In the example of embodiment 300, items 208 and 210 are illustrated as executing. From the scheduling graph, executable elements 206, 214, and 216 are identified as potential elements that may be executed next.

The dependent elements 206, 214, and 216 may be identified by traversing the graph 300 starting with the executing elements and evaluating the relationships to the other elements. An execution environment may place the dependent elements 206, 214, and 216 into an idle queue, while other items may not be placed in the idle queue.

As new items begin execution, the execution environment may again analyze the scheduling graph to determine which new elements may be dependent, then add the new elements to the idle queue.

Similarly, as the set of executing elements change, the scheduling graph may be analyzed to identify items that are no longer reachable from the executing items. Such items that are no longer reachable may be removed from the idle queue.

The example of embodiment 300 shows an example where a first generation of dependent items may be identified. In other embodiments, a two-generational analysis may identify all of the elements that have two dependent relationships to an executing element. Other embodiments may perform analyses that examine three, four, or more generations of dependent elements.

Embodiments that use multi-generational analysis may perform analyses on a less frequent basis than embodiments that perform analyses on fewer generations. However, multi-generational analyses may create a larger queue of idle elements that may be managed.

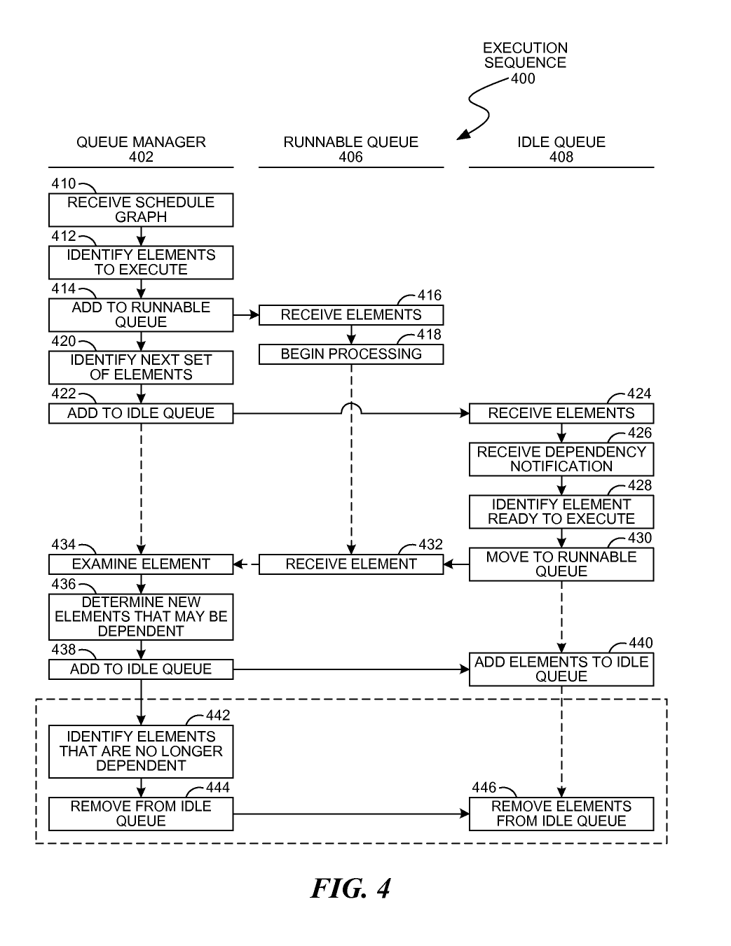

FIG. 4 is a flowchart illustration of an embodiment 400 showing a method for managing executable elements defined in a sequence graph. Embodiment 400 illustrates the operations of a queue manager 402 in the left hand column. In the center column, the operations of a runnable queue 406 are shown, and in the right hand column, operations of an idle queue 408 are shown.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 400 illustrates the operations of a system that uses a schedule graph to identify executable elements that are in process and are likely to be processes. Embodiment 400 executes elements in a schedule graph by placing the elements in a runnable queue 406. Those elements that may be called from the executing elements or elements that are blocked or awaiting other input may be placed in an idle queue 408.

In many embodiments, an operating system or execution environment may maintain a data structure that contains the entire graph of all the executable elements being managed. In some embodiments, the graph may contain executable elements for multiple applications, services, operating system level functions, or any other set of executable code that may be performed by a computer system.

A second data structure may be used to store elements being executed as well as elements that may be executed. In some embodiments, a runnable queue and an idle queue may be separate data structures.

The runnable queue 406 may store executable elements that are ready for execution or are currently in execution. Executable elements that are ready for execution may have any input data ready or any interrupts or other messages received for processing.

In some embodiments, a runnable queue 406 may be a single queue that may be accessed by multiple processors. In one such embodiment, any processor that may be ready to process an executable element may flag an executable element as in process and begin executing the associated commands.

In an embodiment with multiple processors, separate runnable queues may be established for each processor or group of processors. In such embodiments, each processor or group of processors may only access executable elements that are assigned to the runnable queue for that processor or processor group.

A schedule graph may be received in block 410 by the queue manager 402. The schedule graph may include executable elements from one application or from many applications. In some embodiments, the schedule graph may include executable elements that define operating system functions as well as application functions.

In block 412, elements to execute may be identified. The elements to be executed may be those elements that start a particular application or for which input data is known and ready.

Executable elements that are ready for execution may be added to the runnable queue in block 414, and the runnable queue 406 may receive the elements in block 416 and begin processing in block 418.

The queue manager 402 may identify a next set of elements in block 420. The next set of elements may be identified by traversing the scheduling graph one generation of relationships. In some embodiments, two, three, or more generations of relationships may be traversed to identify the possible next set of executable elements. These executable elements may be added to the idle queue in block 422.

The idle queue 408 may receive elements in block 424 and store the executable elements. Each executable element in the idle queue 408 may be waiting a dependency, which may be the completion of another executable element, a message passed from another executable element, an input from a device, an interrupt or other alert, or some other dependency.

When a dependency is received in block 426, the corresponding executable element may be retrieved from the idle queue in block 428 and moved to the runnable queue in block 430. Because the scheduling queue limits the number of executable elements that may be stored in the idle queue, the searching performed in block 428 to identify the executable element waiting for the dependency may be very fast.

The runnable queue 406 may receive the executable element in block 432 and being execution of the element.

The queue manager 402 may also receive notice of the newly executing element and may examine the element in block 434 to identify new elements that may be dependent on the newly executing element in block 436. The new elements may be added to the idle queue in block 438, and the idle queue 408 may receive the new elements in block 440.

The queue manager 402 may examine the elements in the idle queue in block 442 to identify any elements that may no longer have dependencies. For example, a first executable element may be processing and two different executable elements may be dependent on the first executable element, so both of the executable elements with the dependency may be added to the idle queue. When the first element finishes processing, one of the two other elements may be launched but the other element may not be, creating an orphan element. The orphan element may be identified in block 442.

The queue manager 402 may remove the orphan elements from the idle queue in block 444, and the idle queue 408 may remove the element in block 446

In some embodiments, the operations of block 442-446 may be performed in a background process that may periodically purge the idle queue of orphaned elements.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A system comprising:
at least one processor;
an operating system executing on said at least one processor, said operating system having a runnable queue comprising runnable executable elements, an idle queue comprising executable elements awaiting a dependency, and an execution engine that causes said runnable executable elements in said runnable queue to be executed;
a queue manager that:
receives a scheduling graph for an application;
identifies a first set of runnable executable elements and adds said first set of runnable executable elements to said runnable queue;
examines said scheduling graph to identify a first set of idle executable elements, each of said idle executable elements having a dependency on one of said runnable executable elements; and
adds said first set of idle executable elements to said idle queue.

2. The system of claim 1, said scheduling graph comprising executable elements from a plurality of applications.

3. The system of claim 1, said first set of idle executable elements comprising a first generation of executable elements dependent on said first set of runnable executable elements.

4. The system of claim 3, said first set of idle executable elements comprising a second generation of executable elements dependent on said first set of runnable executable elements.

5. The system of claim 1, said queue manager that further:
identifies a first executable element having executed until said first executable element has entered a dependent state, said dependent state indicating that said first executable element is dependent on a second executable element.

6. The system of claim 5, said queue manager that further:
examines said scheduling graph to determine that said first executable element is not dependent on one of said runnable executable elements and removes said first executable element from said idle queue.

7. The system of claim 6, said dependent state being a blocked state.

8. The system of claim 1, said first set of idle executable elements comprising idle executable elements that have two generations of dependencies on one of said runnable executable elements.

9. The system of claim 1, said operating system further comprising:
an idle queue manager that:
identifies a second idle executable element in said idle queue that no longer has a dependency on an executable element in said runnable queue and removes said second idle executable element from said idle queue.

10. The system of claim 9, said second idle executable element having been placed in said idle queue when a first executable element was in said runnable queue, said second idle executable element having a dependency on said first executable element.

11. The system of claim 1, said runnable queue comprising executable elements executable by any of said plurality of processors.

12. The system of claim 1, said runnable queue comprising executable elements assigned to specific processors.

13. A method comprising:
receiving a scheduling graph defining a set of executable elements for an application;
identifying a first set of executable elements to execute as part of said application and adding said first set of executable elements to a runnable queue;
examining said scheduling graph to identify a second set of executable elements, each of said second set of executable elements being dependent on at least one of said executable elements in said first set of executable elements and adding said second set of executable elements to an idle queue;
executing said application by an executing method comprising:
scheduling said executable elements in said runnable queue to be executed by a processor system;
determining that a first dependency for a first executable item has been fulfilled, said first executable item being in said idle queue;
moving said first executable item from said idle queue to said runnable queue;
identifying a second executable item being dependent on said first executable item and adding said second executable item to said idle queue.

14. The method of claim 13, said scheduling graph defining a set of executable elements for a plurality of applications.

15. The method of claim 13, said processor system comprising a plurality of processors.

16. The method of claim 15, said runnable queue being accessible by said plurality of processors.

17. The method of claim 12, said executing method further comprising:
identifying a third executable item being dependent on said first executable item and located in said idle queue;
determining that said third executable item is no longer dependent on said first executable item and removing said third executable item to said idle queue.

18. A computer readable storage medium comprising computer executable instructions that perform the method of claim 12.

19. A method comprising:
receiving a scheduling graph defining a set of executable elements for a plurality of applications;
identifying a first set of executable elements to execute and adding said first set of executable elements to a runnable queue;
examining said scheduling graph to identify a second set of executable elements, each of said second set of executable elements being dependent on at least one of said executable elements in said first set of executable elements and adding said second set of executable elements to an idle queue;
for each of said executable elements in said idle queue, identifying a dependency to be fulfilled prior to executing said executable elements in said idle queue;
executing said application by an executing method comprising:
scheduling said executable elements in said runnable queue to be executed by a processor system;
determining that a first dependency for a first executable item has been fulfilled, said first executable item being in said idle queue;
moving said first executable item from said idle queue to said runnable queue;
identifying a second executable item being dependent on said first executable item and adding said second executable item to said idle queue;
identifying a third executable item being dependent on said first executable item and located in said idle queue; and
determining that said third executable item is no longer dependent on said first executable item and removing said third executable item to said idle queue.

20. The method of claim 19, said scheduling graph further comprising functional elements for an operating system service.
